(19) United States
(12) Patent Application Publication
(10) Pub. No.: US 2010/0228648 A1
(43) Pub. Date: Sep. 9, 2010

(54) MOLD MANAGEMENT SYSTEM AND METHOD THEREOF

(75) Inventors: CHUN-LIN ZHOU, Shenzhen City (CN); TENG-CHIAO SHEN, Tu-Cheng (TW); YUN-FENG ZHANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/582,777

(22) Filed: Oct. 21, 2009

(30) Foreign Application Priority Data
Mar. 6, 2009 (CN) 200910300731.7

(51) Int. Cl. G06Q 10/00

(52) U.S. Cl. 705/28; 705/8

(57) ABSTRACT

A mold management system connected to a shopping floor control (SFC) system is operable to manage a plurality of molds. Each of the plurality of molds bears an exclusive barcode containing basic information of the mold. The mold management system includes a query module, a selection module, an input registration module, and a notification module. The query module queries basic information for requested molds in a database, and production information from the SFC system to obtain a scheduled usage history of the requested molds. The selection module selects a mold with usage history most exceeding the scheduled usage history to be outbound. The input registration module updates a usage history of the outbound mold when the outbound mold is to be inbound. The notification module determines whether the inbound mold is to be discarded based on the updated usage history.

### BACKGROUND

1. Technical Field

The disclosure generally relates to mold technology, and more particularly to a mold management system tracking remaining usage histories of a plurality of molds, and a method thereof.

2. Description of Related Art

Remaining usable life of a mold is a key reference when selecting a mold to machine workpieces. If the usable life of the mold is nearing its end, an edge of the mold may be worn out, preventing the mold from meeting the required precision of the workpieces. In a factory, a traditional method of tracking remaining mold life of the mold includes manual recording and updating of mold status by manual operation, which is inconvenient and inefficient as quantities of mold increase. In addition, mistakes can be easily made during the manual operation.

Therefore, a need exists in the industry to overcome the described limitations.

### BRIEF DESCRIPTION OF THE DRAWINGS

FIG. 1 is a schematic diagram of an application environment of a mold management system of the disclosure.

FIG. 2 is a schematic diagram of functional modules of the mold management system of the disclosure.

FIG. 3 is a flowchart of a mold management method of the disclosure.

### DETAILED DESCRIPTION

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

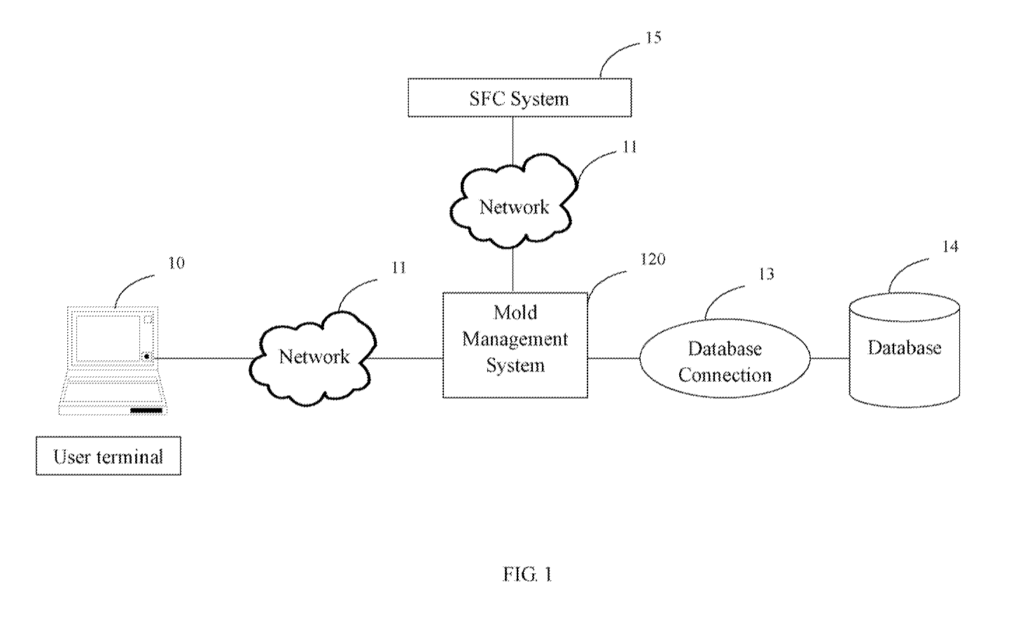

FIG. 1 is a schematic diagram of an application environment of a mold management system 120 of the disclosure operable to manage a plurality of molds. In the illustrated embodiment, the mold management system 120 communicates with a plurality of user terminals 10, and a shopping floor control (SFC) system 15 by way of a communication network 11. A database 14 is connected to the mold management system 120 by a database connection 13, such as java database connectivity (JDBC), or open database connectivity (ODBC). Alternatively, the database 14 can be embedded in the mold management system 120.

In the illustrated embodiment, each of the plurality of molds bears an exclusive barcode containing identity and basic information thereof. The basic information for each mold includes but is not limited to a mold code, a forecasted mold life, a usage history, and a remaining mold life of the mold. The remaining mold life is calculated by subtracting the usage history from the forecasted mold life of the mold.

Each of the user terminals 10 is connected to the mold management system 120 via the communication network 11 and enables relevant operations to mold management to be performed thereon, such as entering new mold information into the database 14, querying basic information of molds, and other functions. In the illustrated embodiment, the user terminals 10 can be industry computers, barcode scanners or other input/output devices. The communication network 11 can be an enterprise intranet, the Internet or other electronic communication network.

The database 14 is operable to database basic information on the plurality of molds. Alternatively, the database 14 may be an internal storage element in the mold management system 120 or other communication network storage modules, such as a network attached storage (NAS).

The SFC system 15 is connected to the mold management system 120 via the communication network 11. Production information for each mold is obtained from the SFC system 15. The production information for each mold comprises a scheduled production quantity and an actual production quantity of a workpiece.

In the exemplary embodiment, the mold management system 120 links to the SFC system 15 according to a mold requisition, and obtains the production information for each mold from the SFC system 15. In the illustrated embodiment, the mold requisition comprises a molding time for machining one workpiece of each of the molds.

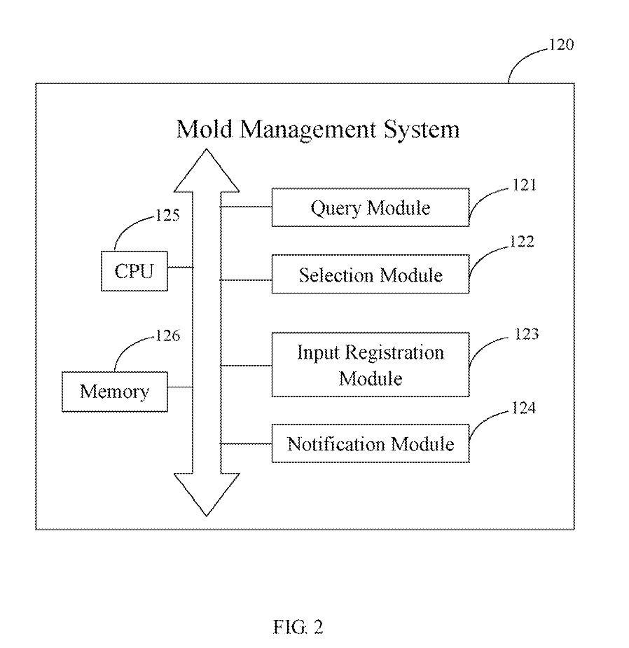

FIG. 2 is a schematic diagram of functional software modules of the mold management system 120 of the disclosure. Here, the mold management system 120 comprises a query module 121, a selection module 122, an input registration module 123, and a notification module 124. In the illustrated embodiment, the functional software modules are stored in a memory 126 of the mold management system 120, and are executed by a central processing unit (CPU) 125 of the mold management system 120.

The query module 11 is configured to query basic information for requested molds from the database 14 according to a mold requisition, and production information for the requested molds in the SFC system 15 to obtain a scheduled usage history for the requested molds based on the production information when the requested molds are outbound. In the illustrated embodiment, the scheduled usage history of the requested molds is obtained by multiplying the scheduled production quantity of the workpiece and the molding time for machining one workpiece of the requested molds.

The selection module 122 is configured to compare the remaining mold life for each of the requested molds with the scheduled usage history respectively, to record the basic information for the molds with a remaining mold life less than the scheduled usage history, and to select the mold with the remaining mold life most exceeding the scheduled usage history to be outbound. In the illustrated embodiment, the basic information on the molds with the remaining mold life less than the scheduled usage history thereof is flagged to highlight its status.

The input registration module 123 is configured to read the basic information of the outbound mold from the barcode thereof when the outbound mold is to be inbound, and to update the usage history and the remaining mold life of the inbound mold based on an actual usage history thereof. In the illustrated embodiment, the input registration module 123 queries an actual production quantity of the workpiece machined by the outbound mold from the SFC system 15, and obtains a current actual usage history of the outbound mold by multiplying actual production quantity of the workpiece and the molding time for machining one workpiece. The usage history of the inbound mold is updated by adding current actual usage history to the existing usage history, and the remaining mold life is updated by subtracting the current usage history from the existing remaining mold life.

The notification module 124 is configured to determine whether the inbound mold is to be discarded based on the updated usage history thereof. If the updated usage history of the inbound mold exceeds the forecasted mold life thereof, the inbound mold is flagged to highlight its status, conversely, basic information on the inbound mold is refreshed.

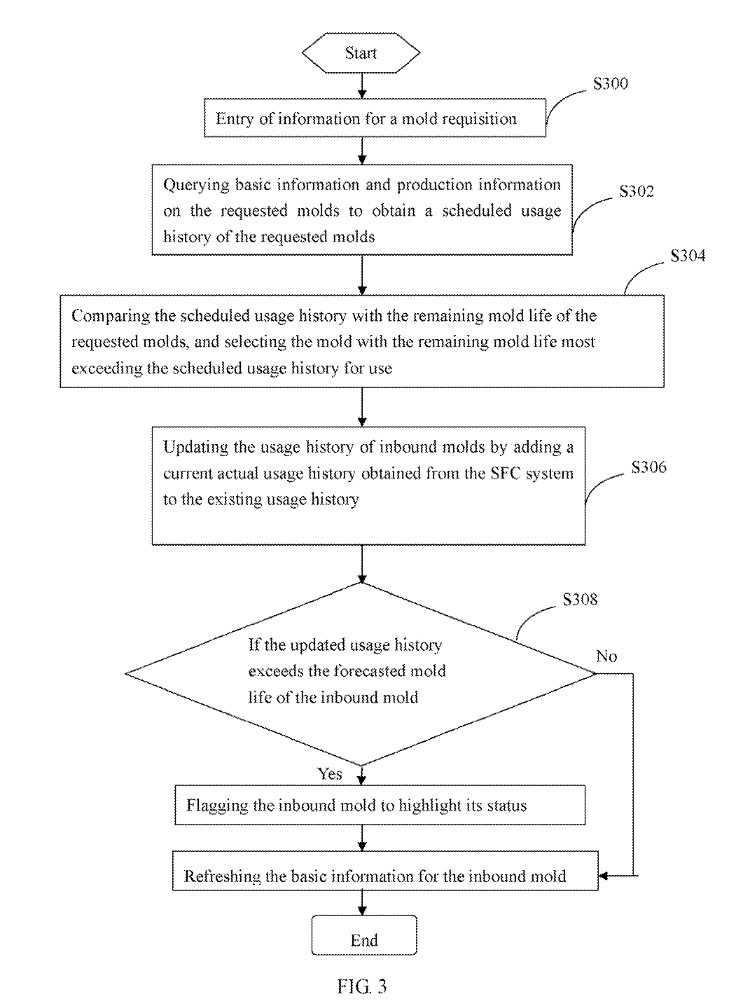

FIG. 3 is a flowchart of a mold management method of the disclosure. The mold management method is implemented via the mold management system 120 in FIG. 2.

In block S300, a mold requisition requests one or more molds to machine a workpiece, with information of the mold requisition entered into an user terminal 10.

In block S302, the query module 121 queries the basic information on requested molds in the database 14 according to the mold requisition, and production information of the requested molds in the SFC system 15 to obtain a scheduled usage history of the requested molds from the production information.

In block S304, the selection module 122 compares the scheduled usage history with the remaining mold life of the requested molds, and selects a mold with the remaining mold life most exceeding the scheduled usage history to be outbound.

In block S306, when the outbound mold is to be inbound, the input registration module 123 updates the usage history of the inbound mold by adding the current actual usage history obtained from the SFC system to the existing usage history. In the illustrated embodiment, the input registration module 123 further updates the remaining mold life of the inbound mold by subtracting the current actual usage history from the existing remaining mold life.

In block S308, the notification module 124 determines whether the inbound mold should be discarded based on the updated usage history if the updated usage history exceeds the forecasted mold life, the basic information on the inbound mold is flagged to highlight its status, and the basic information on the inbound mold is refreshed.

During use of the mold management system of the disclosure, when there is a mold request, information for the mold requisition is entered into the mold management system 120 via a user terminal 10. Subsequently, the mold management system 120 selects requested mold with a remaining mold life most exceeding a scheduled usage history, and displays the progress of the requested mold via the user terminal 10 automatically, the requested mold located accordingly, and the barcode scanned to complete preparation of the outbound mold.

When the outbound mold is inbound, information on the mold requisition is input by a user terminal 10. The mold management system 120 refreshes the basic information of the inbound mold, and at this time, if the updated usage history of the inbound mold exceeds the forecasted mold life thereof, the inbound mold is flagged to highlight its status.

The mold management system 120 of the disclosure combines the SFC system 15 with the mold warehouse operation, and manages the molds via an electronic system, which is convenient and efficient. In addition, the system's selection of the mold with the longest remaining mold life enhances processing precision.

While the exemplary embodiment has been described, it should be understood that it has been presented by way of example only and not by way of limitation. The breadth and scope of the disclosure should not be limited by the described exemplary embodiments, but only in accordance with the following claims and their equivalent.

What is claimed is:

1. A mold management system connected to a shopping floor control (SFC) system via a communication network, to manage a plurality of molds, each of the plurality of molds bearing an exclusive barcode, the mold management system comprising a database of basic information associated with each barcode, and one or more programs that are operable to be executed by a central processing unit (CPU), wherein the basic information comprises a remaining mold life, a usage history, and a forecasted mold life for each of the plurality of molds, and the one or more programs comprise:
a query module configured to query basic information for requested molds from the database according to a mold requisition, and production information for the requested molds in the SFC system to obtain a scheduled usage history of the requested molds from the production information when the requested molds are outbound;
a selection module configured to compare the remaining mold life for each of the requested molds with the scheduled usage history, respectively, to identify molds with a remaining mold life less than the scheduled usage history, and to further select a mold with the remaining mold life most exceeding the scheduled usage history for use;
an input registration module configured to read the basic information from the barcode of inbound molds, and update the usage history for the inbound molds by adding a current actual usage history obtained from the SFC system to the existing usage history; and
a notification module configured to determine whether the inbound molds are to be discarded based on the updated usage history.

2. The mold management system as claimed in claim 1, wherein the input registration module is connected to a plurality of user terminals, and reads the basic information on the barcode of each of the plurality of molds via the user terminals.

3. The mold management system as claimed in claim 1, wherein the production information comprises a scheduled production quantity and an actual production information of a workpiece machined by the requested molds, and wherein the mold requisition comprises a molding time for machining one workpiece of the requested molds.

4. The mold management system as claimed in claim 3, wherein the scheduled usage history of the requested molds is obtained by multiplying the scheduled production quantity of the workpiece and the molding time for machining one workpiece of the requested molds.

5. The mold management system as claimed in claim 3, wherein the input registration module queries the actual production quantity of the workpiece from the SFC system to obtain the current actual usage history for the inbound molds.

6. The mold management system as claimed in claim 5, wherein the input registration module updates the usage history for the inbound molds by subtracting the current actual usage history from the existing usage history.

7. A mold management method utilized by a mold management system connected to a shopping floor control (SFC) via a communication network, to manage a plurality of molds, each of the plurality of molds bearing a barcode, the mold management system comprising a database of basic information associated with each barcode, and one or more programs that are operable to be executed by a central processing unit (CPU), wherein the basic information comprises remaining mold life, usage history, and a forecasted mold life for each of the molds, and the mold management method comprises:
entry of information for a mold requisition via a user terminal;
querying the basic information for requested molds in the database according to the mold requisition, and production information for the requested molds in the SFC system to obtain a scheduled usage history of the requested molds from the production information, when the requested molds are outbound;
comparing the remaining mold life for each of the requested molds with the scheduled usage history, and selecting a mold with the remaining mold life most exceeding the scheduled usage history for use;
updating the usage history of inbound molds by adding a current actual usage history obtained from the SFC system to the existing usage history;
determining whether the inbound molds should be discarded based on the updated usage history, if the updated usage history exceeds the forecasted mold life, flagging the inbound molds to highlight its status, and refreshing the basic information for the inbound molds.

8. The mold management method of claim 7, wherein the production information comprises a scheduled production quantity and an actual production quantity of a workpiece machined by the requested molds, wherein the mold requisition comprises a molding time for machining one workpiece of the requested molds.

9. The mold management method of claim 8, wherein updating the usage history of the inbound molds further comprises querying an actual production quantity of the workpieces from the SFC system to obtain the current actual usage history.
